(19) United States
(12) Patent Application Publication
(10) Pub. No.: US 2013/0322214 A1
(43) Pub. Date: Dec. 5, 2013

(54) ULTRASOUND-BASED LOCALIZATION OF CLIENT DEVICES IN DISTRIBUTED COMMUNICATION SYSTEMS, AND RELATED DEVICES, SYSTEMS, AND METHODS

(71) Applicant: Corning Cable Systems LLC, Hickory, NC (US)

(72) Inventors: Ulrich Wilhelm Heinz Neukirch, Painted Post, NY (US); Kipp David Yeakel, Waverly, NY (US)

(73) Assignee: Corning Cable Systems LLC, Hickory, NC (US)

(21) Appl. No.: 13/900,859

(22) Filed: May 23, 2013

Related U.S. Application Data
(60) Provisional application No. 61/652,586, filed on May 29, 2012.

(51) Int. Cl. G01S 5/20; H04B 11/00

(52) U.S. Cl. CPC G01S 5/20; H04B 11/00
USPC 367/118; 367/137

(57) ABSTRACT

A plurality of spatially located ultrasound beacons are provided in known locations within a distributed communications system. Each of the ultrasound beacons is configured to emit ultrasound pulses that can be received by client devices in ultrasound communication range of the ultrasound beacons. The client devices are configured to analyze the received ultrasound pulses from the beacons to determine their time-difference of arrival and as a result, their location in the distributed communications systems. Use of ultrasound pulses can provide greater resolution in location determination of client devices since ultrasound waves experience strong attenuation in building walls, ceilings, and floors, thus avoiding detection of ultrasound waves from other ultrasound beacons not located in proximity to the client devices.

### PRIORITY APPLICATION

The present application claims the benefit of priority under 35 U.S.C. §119 to U.S. Provisional Patent Application No. 61/652,586 entitled “Ultrasound-Based Localization of Client Devices in Distributed Communication Systems, and Related Devices, Systems, and Methods” and filed on May 29, 2012 which, is incorporated herein by reference in its entirety.

### BACKGROUND

1. Field of the Disclosure

The technology of the disclosure relates to distributed communications systems, and in particular to providing devices, systems, and methods to allow determination of the location of client devices within distributed communications systems.

2. Technical Background

Wireless communication is rapidly growing, with ever-increasing demands for high-speed mobile data communication. As an example, so-called “wireless fidelity” or “WiFi” systems and wireless local area networks (WLANs) are being deployed in many different types of areas. Distributed communications or antenna systems communicate with wireless devices called “clients,” “client devices,” or “wireless client devices,” which must reside within the wireless range or “cell coverage area” to communicate with an access point device. Distributed antenna systems are particularly useful to be deployed inside buildings or other indoor environments where client devices may not otherwise be able to effectively receive radio frequency (RF) signals from a source, such as a base station for example.

One approach to deploying a distributed communications system involves the use of radio frequency (RF) antenna coverage areas, also referred to as “antenna coverage areas.” Antenna coverage areas can have a relatively short range from a few meters up to twenty meters as an example. Combining a number of access point devices creates an array of antenna coverage areas. Because the antenna coverage areas each cover small areas, there are typically only a few users (client devices) per antenna coverage area. This allows for minimizing the amount of bandwidth shared among the wireless system users. It may be desirable to provide antenna coverage areas in a building or other facility to provide distributed communications system access to client devices within the building or facility. Such distributed communications systems can include a head-end unit communicatively coupled to a plurality of remote units that each provides antenna coverage areas. The remote units can each include RF transceivers coupled to an antenna to transmit communications signals (e.g., RF, data) wirelessly. The remote units are coupled to the head-end station via communications media to receive downlink communications signals to be wirelessly transmitted over an antenna in the coverage area to client devices. The remote units also wirelessly receive uplink communications signals from client devices to be communicated to the head-end station.

FIG. 1 is a schematic diagram of an optical fiber-based distributed communications system 10. The distributed communications system 10 is creates one or more antenna coverage areas for establishing communications with wireless client devices (sometimes referred to herein as mobile terminals) located in the radio frequency (RF) range of the antenna coverage areas. The system 10 includes a head-end unit or HEU 12, remote antenna units (RAUs) 14, and an optical fiber link 16 that optically couples the HEU 12 to the RAU 14. The HEU 12 is configured to receive communications over downlink electrical RF signals 18D from a source such as a network or carrier, and to provide such communications to the RAU 14. Such downlink communications signals are received through conventional downlink input(s). The HEU 12 is also configured to return communications received from the RAU 14, via uplink electrical RF signals 18U, back to the sources. The optical fiber link 16 includes an downlink optical fiber 16D to carry signals communicated from the HEU 12 to the RAU 14 and an uplink optical fiber 16U to carry signals communicated from the RAU 14 back to the HEU 12. An interface couples the HEU 12 to the optical fiber link 16. The interface may be a conventional interface as is well understood and is configured to receive downlink communications signals and pass the downlink communications signals to the RAU 14 through the optical fiber link 16.

The wireless system 10 has an antenna coverage area 20 centered about the RAU 14 to form an RF coverage area 22. The HEU 12 is adapted to perform or to facilitate Radio-over Fiber (RoF) applications such as radio-frequency identification (RFID), wireless local-area network (WLAN) communication, or cellular phone service. Shown within the antenna coverage area 20 is a client device 24 in the form of a mobile terminal capable of receiving RF communication signals, such as a cellular telephone or smart phone. The client device 24 includes an antenna 26 (e.g., a bipole, monopole, bowtie, inverted F, a wireless card, or the like) adapted to receive and/or send electromagnetic RF signals.

To communicate the electrical RF signals over the downlink optical fiber 16D to the RAU 14, to in turn be communicated to the client device 24 in the antenna coverage area 20 formed by the RAU 14, the HEU 12 includes an electrical-to-optical (E/O) converter 28. The E/O converter 28 converts the downlink electrical RF signals 18D to downlink optical RF signals 30D to be communicated over the downlink optical fiber 16D. The RAU 14 includes an optical-to-electrical (O/E) converter 32 to convert received downlink optical RF signals 30D back to electrical signals to be communicated wirelessly through an antenna 34 of the RAU 14 to client devices 24 located in the antenna coverage area 20.

The antenna 34 receives wireless RF communications from client devices 24 in the antenna coverage area 20 and communicates electrical RF signals representing the wireless RF communications to an E/O converter 36 in the RAU 14. The E/O converter 36 converts the electrical RF signals into uplink optical RF signals 30U to be communicated over the uplink optical fiber 16U. An O/E converter 38 provided in the HEU 12 converts the uplink optical RF signals 30U into uplink electrical RF signals, which can then be communicated as uplink electrical RF signals 18U back to a network or other source. The client device 24 could be in range of any antenna coverage area 20 formed by a RAU 14.

As noted above, it may be desired to provide the distributed communications system 10 in FIG. 1 indoors, such as inside a building or other facility, to provide indoor wireless communications for the client devices 24. Other services may be negatively affected or not possible due to the indoor environment. For example, it may be desired or required to provide localization services for the client devices 24, such as emergency 911 (E911) services as an example. If a client device is located indoors, techniques such as global positioning services (GPS) may not be effective at providing or determining the location of the client device. Indoors, GPS signals are usually too weak to be received by client devices. Further, triangulation and/or trilateration techniques from the outside network may not be able to determine the location of client devices.

Other methods for determining location of client devices, such as client device 24 in FIG. 1 located indoors, may be based on receiving wireless data signals transmitted by existing wireless data devices provided in wireless communications systems (e.g., cell phone network and/or wireless location area network (WLAN) access points). However, use of existing wireless data signals may only be accurate to down to a resolution of still a relatively large distance (e.g., ten (10) meters) since the client devices may receive wireless data signals from wireless data devices not located in close proximity to the client devices. Further, use of existing wireless data signals may only be accurate to down to a resolution of a relatively large distance unless a greater density of RF communications devices are provided beyond what is required for data communications. Thus, determining location of client devices at lower resolution distances using wireless communications signals transmitted from existing wireless data devices may not be possible without providing additional, greater densities of these wireless data devices at greater cost and complexity.

### SUMMARY OF THE DETAILED DESCRIPTION

Embodiments disclosed herein include ultrasound-based localization of client devices in distributed communications systems, as well as elated devices, systems, and methods. In this regard in embodiments disclosed herein, a plurality of spatially located ultrasound beacons are provided in known locations within the distributed communications systems. Each of the spatially located ultrasound beacons is configured to emit ultrasound pulses that can be received by client devices in ultrasound communication range of the ultrasound beacons. The client devices are configured to analyze the received ultrasound pulses from the plurality of ultrasound beacons to determine their time-difference of arrivals at the client device. As a result, the client devices can determine their relative distance to ultrasound beacons in a distributed communications system. In certain embodiments, a master ultrasound beacon is provided that encodes location information in a second channel with emitted ultrasound pulses received by the client devices that can be used with the determined relative distance to determine location of the client device in the distributed communications system.

Distributed communications systems employing ultrasound beacons can facilitate the determining and/or providing of location information to client devices, including wireless client devices, that may not otherwise be able to receive, for example, global positioning system (GPS) information from the GPS satellites. Providing location information to client devices inside a building or other location may make location-based services possible (e.g., emergency 911 (E911) services) based on the determined location information of the client devices.

Use of ultrasound pulses by a client device to determine its location in a distributed communications system can provide greater resolution (e.g., sub-meter resolution) in location determination. Increased resolution results from the lower velocity of sound (as opposed to light or radio-frequency signals), which translates into lessened requirements for time resolution in ultrasound pulse measurements. Ultrasound waves experience strong attenuation in buildings walls, ceilings, and floors, thus the ultrasound beacons can be strategically placed to allow client devices to avoid detection of ultrasound waves from other ultrasound beacons not located in proximity to the client devices (e.g., on a different floor). Use of ultrasound pulses to facilitate location determination using time-difference of arrival can also avoid the need to synchronize the clock of the client device.

According to one embodiment, an ultrasound beacon for facilitating client devices determining their location in a distributed communications system comprises a controller. The ultrasound beacon also comprises an ultrasound emitter coupled to the controller, the ultrasound emitter configured to emit ultrasound pulses over at least one speaker. The ultrasound beacon also comprises a radio-frequency (RF) receiver coupled to the controller and configured to receive RF synchronization signals comprising synchronization information. The controller is configured to synchronize an internal clock based on the received synchronization information, and to cause the ultrasound emitter to emit ultrasound pulses in synchronization based on the synchronization information with other ultrasound beacons among an ultrasound beacon cluster, to client devices located in the distributed communications system.

In another embodiment, a method of emitting ultrasound pulses from an ultrasound beacon in synchronization with other ultrasound beacons to client devices in a distributed communications system to facilitate the client devices determining their location in the distributed communications system comprises receiving RF synchronization signals comprising synchronization information. The method also comprises emitting ultrasound pulses in synchronization based on the synchronization information with other ultrasound beacons among an ultrasound beacon cluster, to client devices located in the system.

In another embodiment, a distributed communications system comprises an ultrasound beacon cluster comprised of a master ultrasound beacon and a plurality of non-master ultrasound beacons. The master ultrasound beacon and the plurality of non-master ultrasound beacons are each configured to receive RF synchronization signals comprising synchronization information, and to emit ultrasound pulses to client devices located within the system in synchronization with the other ultrasound beacons in the ultrasound beacon cluster based on the synchronization information. The master ultrasound beacon is further configured to periodically encode location information of the master ultrasound beacon and the plurality of non-master ultrasound beacons in the ultrasound pulses emitted to the client devices.

In another embodiment, a method of emitting ultrasound pulses from an ultrasound beacon in synchronization with other ultrasound beacons to client devices in a distributed communications system to facilitate the client devices determining their location in the distributed communications system is provided. The method comprises a master ultrasound beacon and a plurality of non-master ultrasound beacons in an ultrasound beacon cluster each receiving RF signals comprising synchronization information, and emitting ultrasound pulses to client devices located in the distributed communications system in synchronization with the other ultrasound beacons in the ultrasound beacon cluster based on the synchronization information. The method also comprises the master ultrasound beacon periodically encoding location information of the master ultrasound beacon and the plurality of non-master ultrasound beacons in the ultrasound pulses emitted to the client devices.

In another embodiment, a client device configured to communicate in a distributed communications system comprises a controller, and an ultrasound receiver coupled to the controller. The ultrasound receiver is configured to receive ultrasound pulses over at least one microphone. The client device also comprises an RF transceiver coupled to the controller, the RF transceiver configured to receive and transmit RF communications signals over at least one antenna. The controller is configured to record sound received from a plurality of ultrasound beacons over the microphone(s) over a defined period of time, and to filter the recorded sound about at least one ultrasound beacon frequency. The controller is also configured to recover a plurality of ultrasound pulses from the filtered recorded sound emitted from a plurality of ultrasound beacons in the distributed communications system. The controller is also configured to perform a time-difference-of-arrival analysis on the recovered plurality of ultrasound pulses, and to determine a relative distance of the client device to the plurality of ultrasound beacons.

In another embodiment, a method of an RF communications client device configured to communicate in a distributed communications system determining location within the distributed communications system is provided. The method comprises recording sound received from a plurality of ultrasound beacons over at least one microphone over a defined period of time. The method also comprises filtering the recorded sound about at least one ultrasound beacon frequency, and recovering a plurality of ultrasound pulses from the filtered recorded sound emitted from a plurality of ultrasound beacons in the distributed communications system. The method also comprises performing a time-difference-of-arrival analysis on the recovered plurality of ultrasound pulses, and determining a relative distance of the client device to the plurality of ultrasound beacons.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification.

### BRIEF DESCRIPTION OF THE FIGURES

FIG. 1 is a schematic diagram of an optical fiber-based distributed communications system;

FIG. 2 is a schematic diagram of an exemplary distributed communications system employing a plurality of ultrasound beacons organized in ultrasound beacon clusters and configured to emit ultrasound pulses to be received by client devices in the distributed communications system used by the client devices to determine their location in the distributed communications system;

FIG. 3 is a schematic diagram of an exemplary distributed communications system employing ultrasound beacon clusters in different floors of a building;

FIG. 4 is a flowchart illustrating an exemplary process of an ultrasound beacon receiving radio-frequency (RF) signals including synchronization information used by ultrasound beacons to synchronize their internal clocks used to control ultrasound pulse emission;

FIG. 5 is a schematic diagram of an exemplary ultrasound beacon that can be employed in the distributed communications system in FIG. 2, wherein the ultrasound beacon may be a master ultrasound beacon or a non-master ultrasound beacon;

FIG. 6 is a flowchart illustrating an exemplary process of an ultrasound beacon emitting ultrasound pulses to be received by client devices, which can be used by the client devices to determine their location in a distributed communications system;

FIGS. 7A and 7B are flowcharts illustrating an exemplary process of a client device receiving ultrasound pulses from ultrasound beacons and the client devices using the time-difference-of-arrival of the received ultrasound pulses to determine location in a distributed communications system;

FIG. 8 is a schematic diagram of an exemplary client device configured with an ultrasound receiver configured to receive ultrasound pulses and/or location information encoded in ultrasound pulses emitted by ultrasound beacons in a distributed communications system; and

FIG. 9 is a schematic diagram illustrating exemplary ultrasound beacons, which may be the exemplary ultrasound beacon in FIG. 4, included in remote units in a distributed communications system, which may be the distributed communications system in FIG. 2.

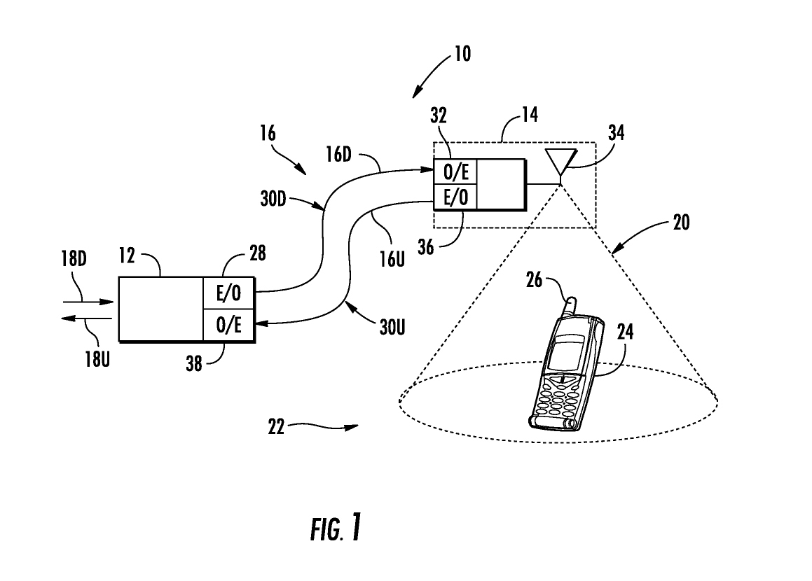

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed herein include ultrasound-based localization of client devices in distributed communications systems. Related devices, systems, and methods are also disclosed. In this regard in embodiments disclosed herein, a plurality of spatially located ultrasound beacons are provided in known locations within the distributed communications systems. Each of the spatially located ultrasound beacons is configured to emit ultrasound pulses that can be received by client devices in ultrasound communication range of the ultrasound beacons. Ultrasound is sound at one or more wave frequencies higher than what humans can hear. The upper frequency limit of human hearing is different for different individuals and decreases with increasing age. For example, the lower limit of ultrasound wave frequencies may be approximately 16 KHz or 20 KHz, as non-limiting examples. Ultrasound pulses are bursts of ultrasound waves.

The client devices are configured to analyze the received ultrasound pulses from the plurality of ultrasound beacons to determine their time-difference of arrivals at the client device. As a result, the client devices can determine their relative distance to ultrasound beacons in a distributed communications system. In certain embodiments, a master ultrasound beacon is provided that encodes location information in a second channel with emitted ultrasound pulses received by the client devices that can be used with the determined relative distance to determine location of the client device in the distributed communications system.

In this regard, the distributed communications systems employing ultrasound beacons to provide ultrasound-based localization services disclosed herein can facilitate the determining and/or providing of location information to client devices, including wireless client devices, that may not otherwise be able to receive, for example, global positioning system (GPS) information from the GPS satellites. Providing location information to client devices inside a building or other location may make location-based services possible (e.g., emergency 911 (E911) services) based on the determined location information of the client devices.

Use of ultrasound pulses by a client device to determine its location in a distributed communications system can provide greater resolution (e.g., sub-meter resolution) in location determination. Increased resolution results from the lower velocity of sound (as opposed to light or radio-frequency signals), which translates into lessened requirements for time resolution in ultrasound pulse measurements. Ultrasound waves experience strong attenuation in buildings walls, ceilings, and floors, thus the ultrasound beacons can be strategically placed to allow client devices to avoid detection of ultrasound waves from other ultrasound beacons not located in proximity to the client devices (e.g., on a different floor). Use of ultrasound pulses to facilitate location determination using time-difference of arrival can also avoid the need to synchronize the clock of the client device.

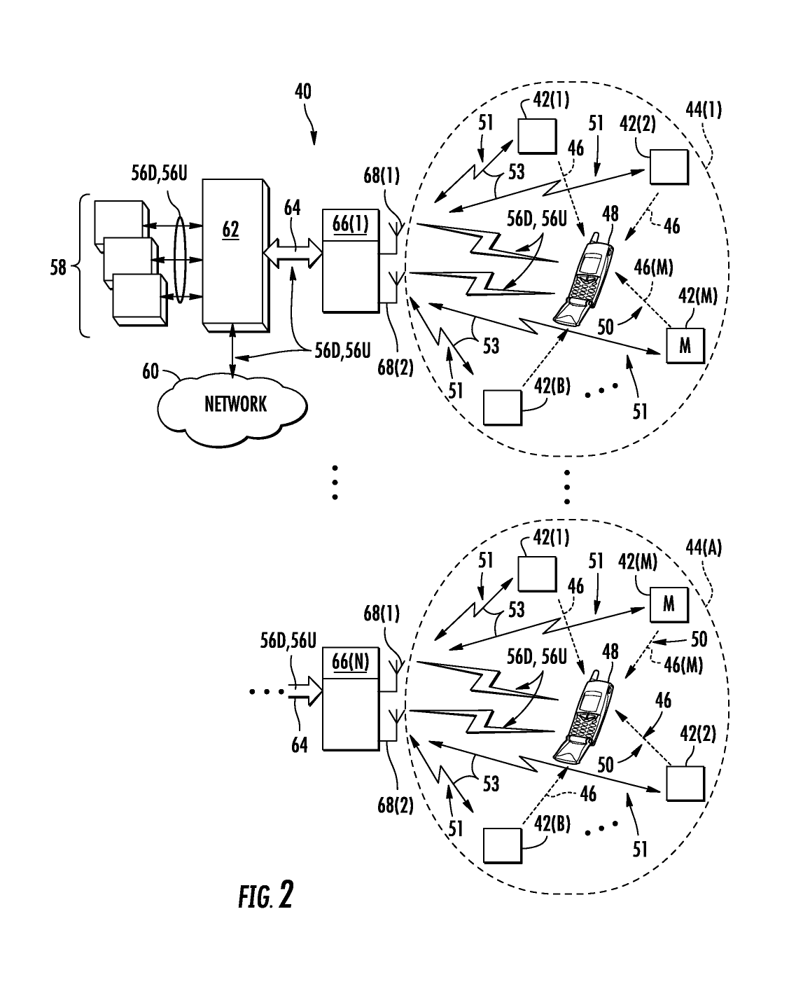

In this regard, FIG. 2 is a schematic diagram of an exemplary distributed communications system 40 employing a plurality of ultrasound beacons 42 organized in ultrasound beacon clusters 44. The ultrasound beacons 42 are configured to emit ultrasound pulses 46 to be received by client devices 48 in the distributed communications system 40. The distributed communications system 40 may be provided indoors in a building or other structure where it is difficult or impossible for the client device 48 to receive global positioning system (GPS) signals to determine location. In this example, a plurality of ultrasound beacon clusters 44(1)-44(A) are provided, wherein ‘A’ can be any positive whole integer. Each ultrasound beacon cluster 44(1)-44(A) includes a plurality of non-master ultrasound beacons 42(1)-42(B) and one master ultrasound beacon 42(M) in this example, wherein ‘B’ can be any positive whole integer.

The master ultrasound beacons 42(M) are configured to encode as location information 50, their location and the location of the other ultrasound beacons 42(1)-42(B) in their ultrasound beacon cluster 44 with the ultrasound pulses 46(M) emitted to the client devices 48. The client devices 48 receive ultrasound pulses 46 from other ultrasound beacons 42(1)-42(B). The client devices 48, equipped with a microphone to detect the ultrasound pulses 46 and other components, are configured to determine their location using the received location information 50 and determining the time-difference-of-arrival between the different received ultrasound pulses 46, 46(M). The client devices 48 use time-difference-of-arrival analysis to determine their location relative to the master ultrasound beacon 42(M) and the non-master ultrasound beacons 42(1)-42(B) in the system 40. The determined location of the client devices 48 can be provided to another device or network for any purpose desired.

The ultrasound beacons 42(1)-42(B), 42(M) are also capable of receiving synchronization information 51 over received communications signals or synchronization signals, which are RF synchronization signals 53 in this example. The synchronization signals could be provided by other communications methods or mediums. In this example, the RF synchronization signals 53 can be distributed by the remote units 66(1)-66(N) in the distributed communications system 40 to the ultrasound beacons 42(1)-42(B), 42(M) as one convenient method. Regardless of the distribution method of the RF synchronization signals 53, the synchronization information 51 is used by the ultrasound beacons 42(1)-42(B), 42(M) to synchronize their internal clocks used to control emission of the ultrasound pulses 46, 46(M). In this manner, the client devices 48 can distinguish between ultrasound pulses 46, 46(M) received from different ultrasound beacons 42(1)-42(B), 42(M) to analyze their time-difference-of-arrivals to determine location. By synchronizing the ultrasound beacons 42(1)-42(B), 42(M), the client devices 48 do not have to be synchronized with the ultrasound beacons 42(1)-42(B), 42(M).

With continuing reference to FIG. 2, note that different numbers of ultrasound beacons 42 can be provided in different ultrasound beacon clusters 44(1)-44(A) as long as at least one master ultrasound beacon 42(M) and a plurality of other non-master ultrasound beacons 42(1)-42(B) are provided in each ultrasound beacon cluster 44(1)-44(A). The ultrasound beacon clusters 44(1)-44(A) may be arranged in the distributed communications system 40 such that a client device 48 can receive ultrasound pulses 46 only from ultrasound beacons 42 in one ultrasound beacon cluster 44(1)-44(A) for a given location of the client device 48. This limitation can be provided as range limitations by placement of the ultrasound beacon clusters 44(1)-44(A) with respect to each other and/or differences in carrier frequencies as non-limiting examples. In this manner, the client device 48 does not receive ultrasound pulses 46 from two different ultrasound beacon clusters 44(1)-44(A) that cannot be compared in a time-difference-of-arrival analysis for a given location of the client device 48. Also, the client device 48 would not receive location information 50 from multiple master ultrasound beacons 42(M) in a given location of the client device 48.

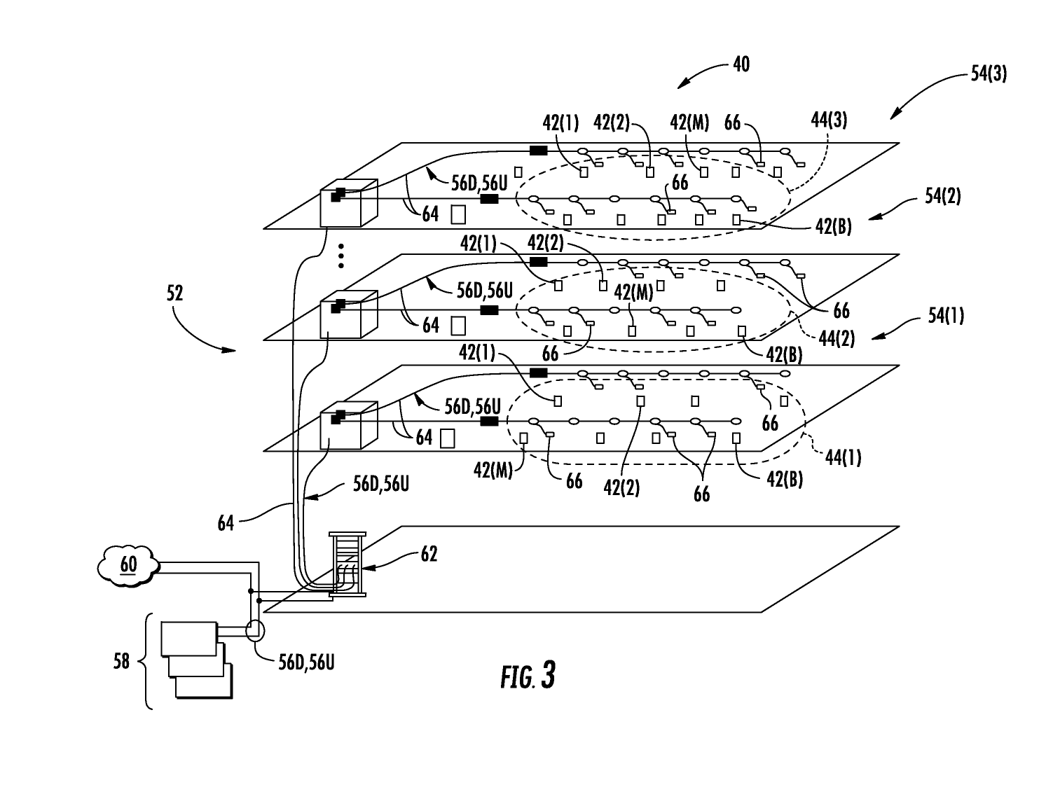

For example, as illustrated in FIG. 3, the distributed communications system 40 may be provided in a building infrastructure 52. The ultrasound beacon clusters 44(1)-44(A) may be on each floor of a building infrastructure 52. For example, the ultrasound beacon cluster 44(1) may be provided on a first floor 54(1) of the building infrastructure 52. The ultrasound beacon cluster 44(2) may be provided on a second floor 54(2) of the building infrastructure 52. The ultrasound beacon cluster 44(3) may be provided on the third floor 54(1) of the building infrastructure 52.

With reference to FIGS. 2 and 3, the ultrasound beacon clusters 44(1)-44(A) are configured to be provided in the distributed communications system 40 that is also configured to downlink and uplink distributed communications signals 56D, 56U from base stations 58 and/or a network 60 to and from the client device 48. In this regard, a central unit 62 is provided that is configured to receive downlink communications signals 56D from the base stations(s) 58 and/or the network 60 for distribution of a communications media 64 to one or more remote units 66(1)-66(N). The remote units 66(1)-66(N) include at least one RF antenna 68(1), 68(2) configured to radiate the downlink communication signals 56D to the client devices 48. Multiple RF antennas 68(1), 68(2) may be provided for multiple input, multiple output (MIMO) communications. The remote units 66(1)-66(N) are also configured to receive uplink communication signals 56U from the client devices 48 to be distributed over the communications media 64 to the central unit 62 to be provided to the base station(s) 58 and/or the network 60.

With continuing references to FIGS. 2 and 3, the communications media 64 in the distributed communications system 40 could be one or a plurality of communications medium, and/or any of different types. For example, the communications media 64 may be electrical conductors, such as twisted-pair wiring or coaxial cable. Frequency division multiplexing (FDM) or time division multiplexing (TDM) can be employed to provide the downlink and uplink communications signals 56D, 56U between the central unit 62 and the remote units 66(1)-66(N). Alternatively, separate, dedicated communications media 64 may be provided between the central unit 62 and the remote units 66(1)-66(N). Further, the downlink and uplink communications signals 56D, 56U could include digital data signals and/or RF communications signals.

Examples of digital data services provided with digital data signals include, but are not limited to, Ethernet, WLAN, WiMax, WiFi, Digital Subscriber Line (DSL), and LTE, etc. Ethernet standards could be supported, including but not limited to 100 Megabits per second (Mbs) (i.e., fast Ethernet) or Gigabit (Gb) Ethernet, or ten Gigabit (10G) Ethernet. Examples of RF communications services provided with RF communications signals include, but are not limited to, US FCC and Industry Canada frequencies (824-849 MHz on uplink (UL) and 869-894 MHz on downlink (DL)), US FCC and Industry Canada frequencies (1850-1915 MHz on UL and 1930-1995 MHz on DL), US FCC and Industry Canada frequencies (1710-1755 MHz on UL and 2110-2155 MHz on DL), US FCC frequencies (698-716 MHz and 776-787 MHz on UL and 728-746 MHz on DL), EU R & TTE frequencies (880-915 MHz on UL and 925-960 MHz on DL), EU R & TTE frequencies (1710-1785 MHz on UL and 1805-1880 MHz on DL), EU R & TTE frequencies (1920-1980 MHz on UL and 2110-2170 MHz on DL), US FCC frequencies (806-824 MHz on UL and 851-869 MHz on DL), US FCC frequencies (896-901 MHz on UL and 929-941 MHz on DL), US FCC frequencies (793-805 MHz on UL and 763-775 MHz on DL), and US FCC frequencies (2495-2690 MHz on UL and DL), and medical telemetry frequencies.

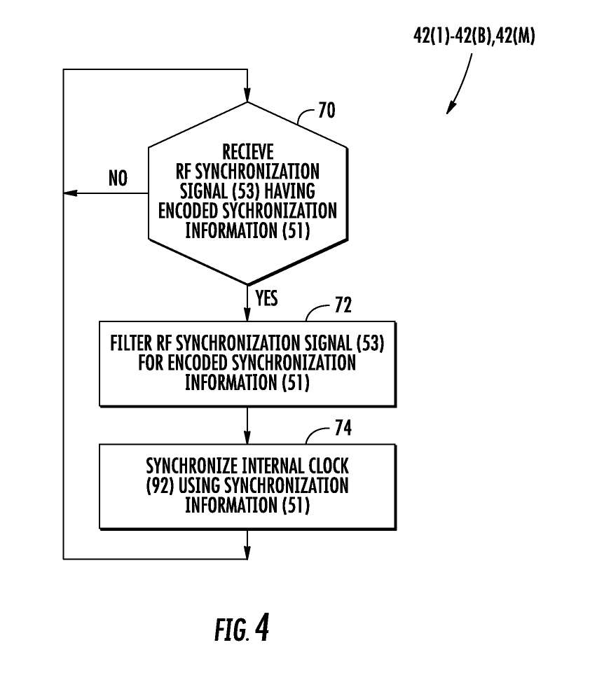

As discussed above with regard to distributed communications system 40 in FIG. 2 the ultrasound beacons 42(1)-42(B), 42(M) are synchronized. This is opposed to having to synchronize the client devices 48 to the ultrasound beacons 42(1)-42(B), 42(M). The ultrasound beacons 42(1)-42(B), 42(M) are synchronized to each other so that the ultrasound pulses 46, 46(M) are emitted by the ultrasound beacons 42(1)-42(B), 42(M) in synchronization to the client devices 48. In this manner, the client devices 48 can distinguish between ultrasound pulses 46, 46(M) received from different ultrasound beacons 42(1)-42(B), 42(M) to analyze their time-difference-of-arrivals to determine location. FIG. 4 is a flowchart illustrating an exemplary process of an ultrasound beacon 42(1)-42(B), 42(M) receiving RF synchronization signals 53 including synchronization information 51. The synchronization information 51 is used by the ultrasound beacons 42(1)-42(B), 42(M) to synchronize their internal clocks used to synchronize ultrasound pulse 46, 46(M) emission. Alternatively, the synchronization information 51 may be a central clock signal that is received by all ultrasound beacons 42(1)-42(B), 42(M) and used to synchronize ultrasound pulse 46, 46(M) emission.

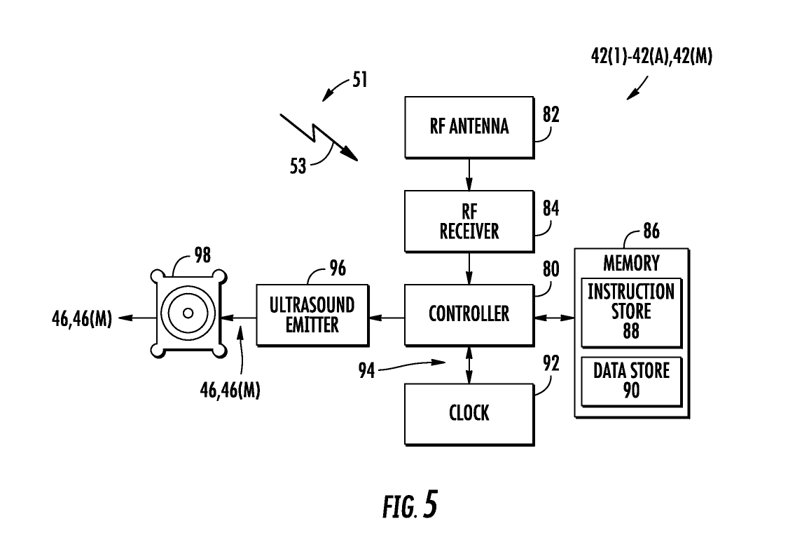

With reference to FIG. 4, a controller 80 of the ultrasound beacon 42(1)-42(B), 42(M), which is schematically illustrated in FIG. 5 determines if a RF synchronization signal 53 having encoded synchronization information 51 has been received (block 70 in FIG. 4). As illustrated in FIG. 5, the ultrasound beacon 42(1)-42(B), 42(M) includes an RF antenna 82 coupled to a RF receiver 84. The RF antenna 82 is configured to receive the RF synchronization signal 53 having the encoded synchronization information 51. For example, the RF synchronization signal 53 may be communicated using a radio frequency identification (RFID), Zigbee, or Dash7 protocol, as non-limiting examples. The RF antenna 82 is coupled to the RF receiver 84, which is configured to provide the encoded synchronization information 51 to the controller 80. The controller 80 is coupled to memory 86 that includes instruction store 88 and data store 90. The instruction store 88 contains instructions executed by the controller 80 to control the operations of the ultrasound beacon 42(1)-42(B), 42(M). The data store 90 allows the synchronization information 51 to be stored as well as other data, such as an identification indicia of the ultrasound beacon 42(1)-42(B), 42(M), as examples.

With continuing reference to FIG. 4, the controller 80 can filter the RF synchronization signal 53 for the encoded synchronization information 51 (block 72 in FIG. 4). The controller 80 can then use the synchronization information 51 to synchronize an internal clock 92 in the ultrasound beacon 42(1)-42(B), 42(M), as illustrated in FIG. 5 (block 74 in FIG. 4). The internal clock 92 emits a clock signal 94 that is used by controller 80 to control the emission of ultrasound pulses 46, 46(M). The controller 80 is coupled to an ultrasound emitter 96 that is configured to emit the ultrasound pulses 46, 46(M). The ultrasound emitter 96 is coupled to at least one speaker 98 that emits the ultrasound pulses 46, 46(M) as sound that can be received and recorded by the client devices 48 to perform time-difference-of-arrival analysis to determine the location of the client device 48 in the distributed communications system 40.

The synchronization information 51 may be used by the ultrasound beacons 42(1)-42(B), 42(M) to emit ultrasound pulses 46, 46(M) in sequence. The sequence of ultrasound pulses 46, 46(M) arriving at a client device 48 is the same as the emission sequence and temporal overlap of ultrasound pulses 46, 46(M) is avoided. In this manner, there is sufficient separation in the received ultrasound pulses 46, 46(M) for the client device 48 to be able to distinguish the receipt of the ultrasound pulses 46, 46(M) as being emitted from particular ultrasound beacons 42(1)-42(B), 42(M). The client device 48 can determine its location by subtracting timing offsets from the ultrasound pulse 46, 46(M) arrival times to determine the relevant propagation-induced time-difference-of-arrival.

The ultrasound pulse 46, 46(M) emission time offsets may be configured based on the synchronization information 51 to be larger than the maximum propagation time possible. The maximum propagation time possible depends on size in which an ultrasound beacon cluster 44(1)-44(A) is disposed and the speed of sound at approximately 330 meters per second (m/s) (i.e., about 1 foot per millisecond (ms)). For example, the ultrasound beacons 42(1)-42(B), 42(M) may be configured to emit ultrasound pulses 46, 46(M) in approximately one millisecond (1 ms) durations to minimize or eliminate temporal overlap.

As another synchronization example, the ultrasound pulses 46, 46(M) could be emitted by different ultrasound beacons 42(1)-42(B), 42(M) simultaneously or substantially simultaneously with the different ultrasound beacons 42(1)-42(B), 42(M) emitting ultrasound pulses 46, 46(M) at different carrier frequencies. Temporal overlap of received ultrasound pulses 46, 46(M) by the client devices 48 can be tolerated since the ultrasound pulses 46, 46(M) are separated in the frequency domain. The client devices 48 can distinguish which ultrasound beacons 42(1)-42(B), 44(M) emitted which ultrasound pulses 46, 46(M) in a spectral analysis of the received ultrasound pulses 46, 46(M).

As another synchronization example, the ultrasound pulses 46, 46(M) could be emitted by different ultrasound beacons 42(1)-42(B), 42(M) and at different carrier frequencies. In this manner the sequence of ultrasound pulses 46, 46(M) arriving at a client device 48 is the same as the emission sequence and temporal overlap of ultrasound pulses 46, 46(M) is avoided. The client devices 48 can also distinguish which ultrasound beacons 42(1)-42(B), 442(M) emitted which ultrasound pulses 46, 46(M) in a spectral analysis of the received ultrasound pulses 46, 46(M). This example may be particular useful for larger rooms or areas requiring a larger number of ultrasound beacons 42(1)-42(B), 42(M) to unambiguously associate ultrasound pulses 46, 46(M) as being emitted by particular ultrasound beacons 42(1)-42(B), 42(M).

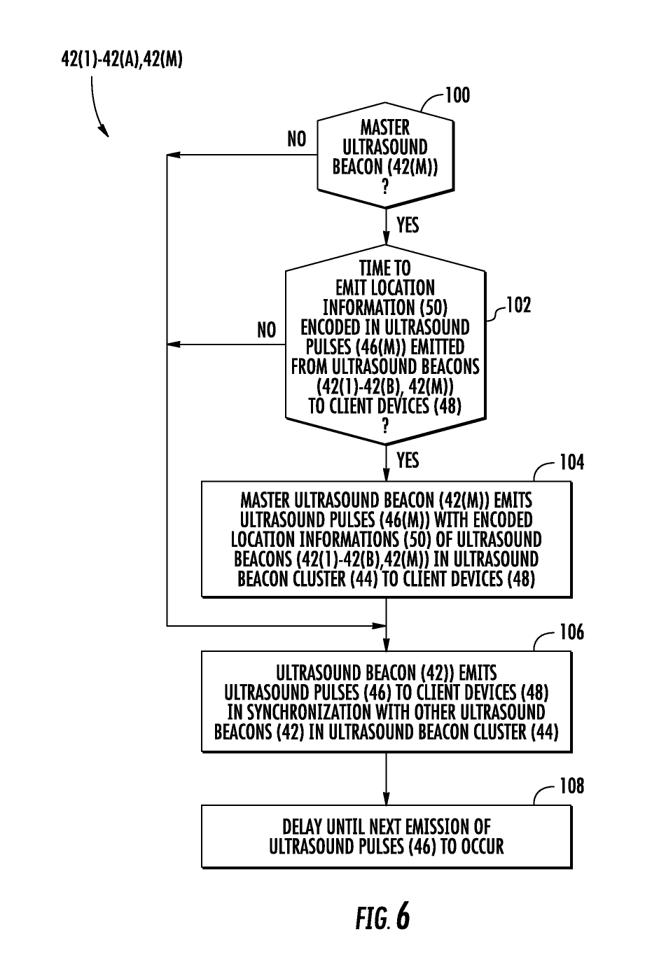

FIG. 6 is a flowchart illustrating an exemplary process of an ultrasound beacon 42(1)-42(B), 42(M) emitting ultrasound pulses 46, 46(M) to be received by the client devices 48 to determine their location. As discussed above, the master ultrasound beacon 42(M) is configured to encode location information 50 of all the ultrasound beacons 42(1)-42(B), 42(M) in ultrasound pulses 46(M) emitted by the master ultrasound beacon 42(M) to the client devices 48. For example, the location information 50 could be enclosed in a coding scheme, such as frequency-shift-keying (FSK) for example, or other coding schemes, using the ultrasound pulses 46(M) as an over-the-air interface. Thus, if the ultrasound beacon 42(1)-42(B), 42(M) is a master ultrasound beacon 42(M) (block 100 in FIG. 6), the master ultrasound beacon 42(M) determines if it is time to encode the location information 50 in ultrasound pulses 46(M) to be emitted to the client devices 48 (block 102 in FIG. 6). It may only be desired to periodically, and less often than normal emission of ultrasound pulses 46(M) for time-difference-of-arrival analysis, emit ultrasound pulses 46(M) encoded with the location information 50 to the client devices 48. Alternatively, periodically in this context could mean as often as the ultrasound pulses 46(M) are emitted by the master ultrasound beacon 42(M) for time-difference-of-arrival analysis.

With continuing reference to FIG. 6, if it is time to encode the location information 50 in ultrasound pulses 46(M) to be emitted to the client devices 48 (block 102 in FIG. 6), the controller 80 of the master ultrasound beacon 42(M) causes the ultrasound emitter 96 in FIG. 5 to emit ultrasound pulses 46(M) with encoded location information 50 of the location of the ultrasound beacons 42(1)-42(B), 42(M) in the ultrasound beacon cluster 44 to the client devices 48 (block 104 in FIG. 6). Thereafter, regardless of whether the ultrasound beacon 42 is a master ultrasound beacon 42(M) or a non-master ultrasound beacon 42(1)-42(B), the controller 80 of the ultrasound beacon 42(1)-42(B), 42(M) controls emission of the ultrasound pulses 46(M) to be in synchronization with other ultrasound beacons 42(1)-42(B), 42(M) to the client devices 48 (block 106 in FIG. 6). The synchronization methods employed by the controller 80 can include any of the synchronization techniques previously described above to allow the client devices 48 to distinguish between which particular ultrasound beacons 42(1)-42(B), 42(M) the received ultrasound pulses 46, 46(M) were emitted. The controller 80 may delay the emission of the next ultrasound pulses 46, 46(M) by the ultrasound emitter 96 next depending on the synchronization method employed (block 108 in FIG. 6).

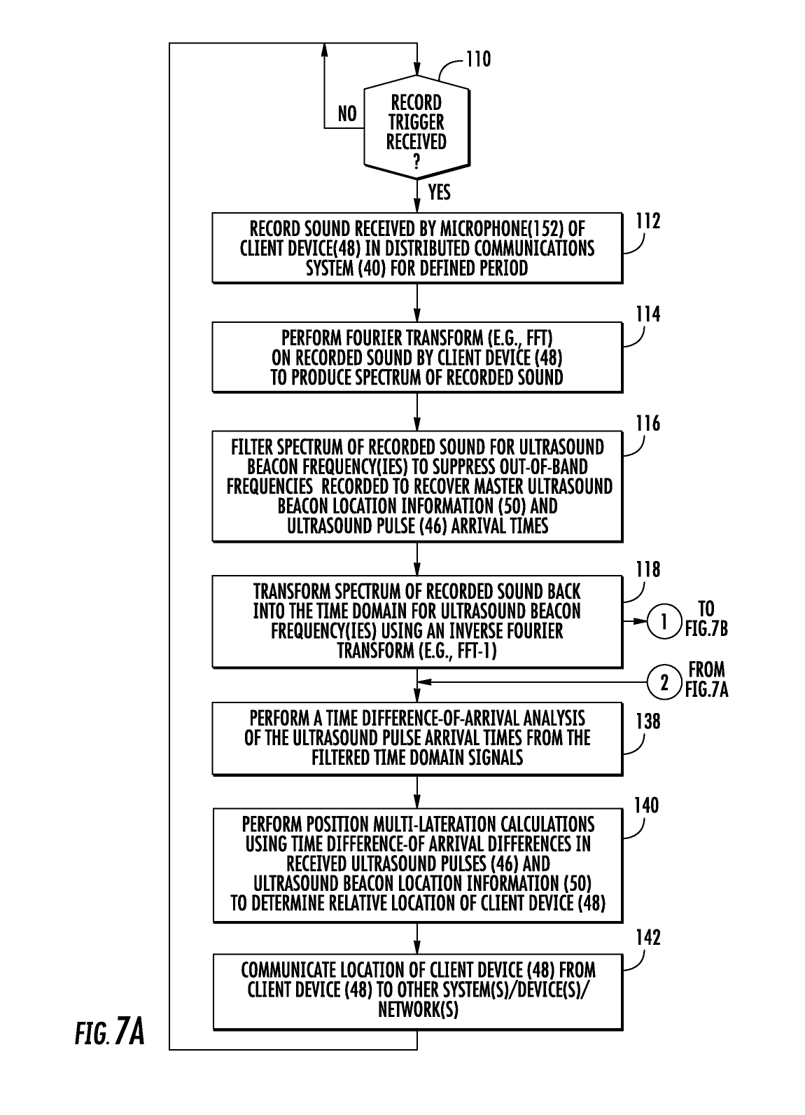

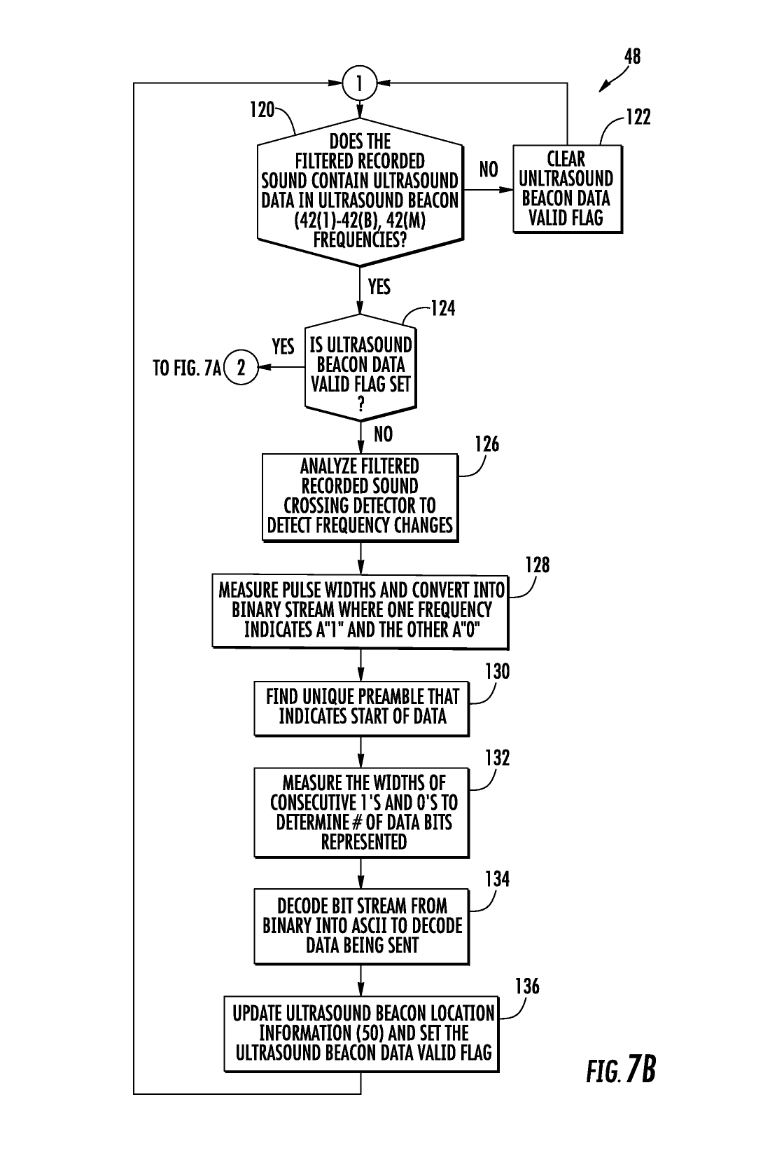

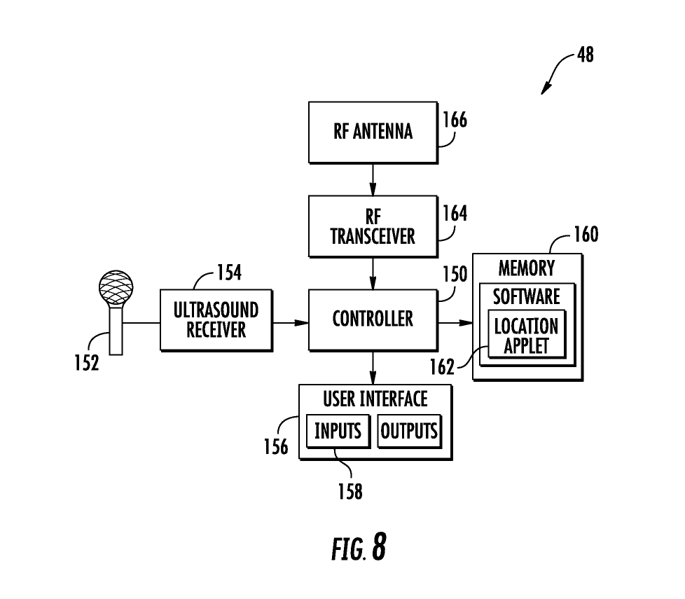

FIGS. 7A and 7B are flowcharts illustrating an exemplary process of the client device 48 receiving ultrasound pulses 46, 46(M) from ultrasound beacons 42(1)-42(B), 42(M) and using the time-difference-of-arrival of the received ultrasound pulses 46, 46(M) to determine location. FIG. 8 is a schematic diagram of an exemplary client device 48 discussed in conjunction with FIGS. 7A and 7B. With reference to FIG. 7A, a controller 150 of the client device 48 (FIG. 8) determines if it is time to record sound received by a microphone 152 coupled to an ultrasound receiver 154 to receive ultrasound pulses 46, 46(M) (block 110 in FIG. 7A). It may be desired for the controller 150 of the client device 48 to only determine location at particular times to conserve power or processing capability of the controller 150. It may also be desired of the controller 150 of the client device 48 to only record sound to receive ultrasound pulses 46, 46(M) when directed by a user through input 158 on a user interface 156 provided in the client device 48.

With continuing reference to FIG. 7A, if it is not time to record sound to receive ultrasound pulses 46, 46(M), the controller 150 continues to make this determination (block 110 in FIG. 7A) until it is time to record sound received by a microphone 152 coupled to an ultrasound receiver 154. When it is time to record sound, the controller 150 directs the ultrasound receiver 154 to receive sound received by the microphone 152 and record the sound in memory 160 for a defined period of time (block 112 in FIG. 7A). The memory 160 also contains the instructions that are executed by the controller 150 to perform the location determination operations discussed herein in this example. For example, these instructions may be provide in a location applet 162 stored in memory 160.

With continuing reference to FIG. 7A, the ultrasound pulses 46, 46(M) are communicated by the ultrasound beacons 42(1)-42(B), 42(M) at one or more carrier frequencies. As discussed above, the ultrasound beacons 42(1)-42(B), 42(M) may be configured to emit ultrasound pulses 46, 46(M) on the same carrier frequency or different, unique carrier frequencies depending on whether ultrasound pulses 46, 46(M) are emitted in sequence synchronization or in simultaneous emission synchronization. Thus, the controller 150 is configured in this example to convert the recorded sound into a frequency domain by performing a Fourier transform on the recorded sound to produce a spectrum of the recorded sound (block 114 in FIG. 7A). The controller 150 may then be configured to filter the spectrum of recorded sound for the expected ultrasound beacon 42(1)-42(B), 42(M) carrier frequency(ies) to recover the location information 50 of the ultrasound beacons 42(1)-42(B), 42(M) and the ultrasound pulse 46, 46(M) arrival times (block 116 in FIG. 7A). Out-of-band frequencies may be filtered out of the recorded sound since the microphone 152 will pick up other surrounding environmental noise, including ambient noise in the recorded sound (block 116 in FIG. 7A).

With continuing reference to FIG. 7A, the controller 150 of the client device 48 may then transform the spectrum of recorded sound back into the time domain via a reverse Fourier transform so that the recorded sound can be analyzed in the time domain for time difference-of-arrival (block 118 in FIG. 7A). The client device 48 can thus perform the exemplary process in FIG. 7B to process the filtered recorded sound to determine if location information 50 for the ultrasound beacons 42(1)-42(B), 42(M) is present in the filtered recorded sound. This processing example is shown assuming the location information 50 is encoded in the ultrasound pulses 46, 46(M) using FSK (Frequency Shift Key) encoding, but other encoding schemes could be employed, such as ASK (Amplitude Shift Keying), PSK (Phase Shift Keying), or other encoding schemes as examples.

In this regard, as a non-limiting example, the client device 48 checks to see if the filtered, recorded sound transmission contains ultrasound pulses or data at the expected carrier frequency(ies) of the ultrasound beacons 42(1)-42(B), 42(M) (block 120 in FIG. 7B). If not, an ultrasound beacon data valid flag can be cleared in memory 160 of the client device 48 indicating that data expected to contain location information 50 is not present in the filtered recorded sound (block 122 in FIG. 7B). The process continues to check to see if the filtered recording sound transmission contains data expected to contain location information 50 (block 120 in FIG. 7B). When data is detected in the filtered recorded sound (block 120 in FIG. 7B), the client device 48 checks to see if the ultrasound beacon 42(1)-42(B), 42(M) locations are already known from prior received filtered recorded sound from the ultrasound beacon 42(1)-42(B), 42(M) by checking the ultrasound beacon data valid flag in memory 160 (block 124 in FIG. 7B). If set, the process returns to block 138 in FIG. 7A to continue with time-difference-of-arrival analysis, since location information 50 has been previously received and stored in memory 160 for use in time-difference-of-arrival analysis. If not set, the filtered recording sound is analyzed to recover the location information 50 for use by the client device 48 to perform time-difference-of-arrival analysis using a software zero crossing detector in this example, which outputs an array in memory 160 that indicates the pulse width of signal above zero and below zero (block 126 in FIG. 7B).

With continuing reference to FIG. 7B, this array indicative of pulse width of signal above zero and below zero can then be passed to a routine, that measures the pulse widths and builds a binary array that indicates if the ultrasound waveform period was representative of a one or zero when encoded (block 128 in FIG. 7B). This array is then passed to a routine that looks for a preamble (indicated by a stream of ones longer than a single transmitted byte) (block 130 in FIG. 7B). The binary data present after the preamble is the desired data, which is a series of ones and zeros in which there are two (2) entries for one (1) cycle of the encoded frequency burst in this example (block 132 in FIG. 7B). The widths of the binary data are measured, and the original encoded binary data is reconstituted (block 134 in FIG. 7B). This binary data has all framing bits removed, and is converted to ASCII (block 134 in FIG. 7B). The ultrasound beacon 42(1)-42(B), 42(M) locations are determined from the data received, either directly (i.e. GPS coordinates were sent) or indirectly (i.e. a database key was sent, a lookup performed, and the coordinates are populated as the location information 50, as non-limiting examples (block 136 in FIG. 7B).

With reference back to FIG. 7A, with location information 50 obtained from ultrasound beacons 42(1)-42(B), 42(M), the controller 150 can then perform a time-difference-of-arrival analysis of the received ultrasound pulses 46, 46(M) from the filtered recorded sound in the time domain (block 138 in FIG. 7A). The controller 150 can determine its distance from the ultrasound beacons 42(1)-42(B), 42(M) in which ultrasound pulses 46, 46(M) are received based on associating the time-difference in the arrival of the ultrasound pulses 46, 46(M) with particular pairs of ultrasound beacons 42(1)-42(B), 42(M). Examples of time-difference-of-arrival analysis can be found in K. C. Ho and Y. T. Chan, IEEE Transactions on Aerospace and Electronic Systems, Vol. 29, No. 4, October 1993, pp. 1311-1322, which is incorporated herein by reference in its entirety. This time-difference-of-arrival analysis provides the relative distance of the client device 48 from the ultrasound beacons 42(1)-42(B), 42(M) in which ultrasound pulses 46, 46(M) are received. The controller 150 of the client device 48 can then perform position multi-lateration calculations using the time-difference-of-arrival information from the received ultrasound pulses 46, 46(M) and the location information 50 of the ultrasound beacons 42(1)-42(B), 42(M) to determine the relative location of the client device 48 to the ultrasound beacons 42(1)-42(B), 42(M) (block 140 in FIG. 7A). This relative location can be determined if ultrasound pulses 46, 46(M) from at least two (2) ultrasound beacons 42(1)-42(B), 42(M) are received by the client device 48. This relative location may be only relative to the location information 50 of the ultrasound beacons 42(1)-42(B), 42(M) provided to the client device 48. Location information 50 from two ultrasound beacons 42(1)-42(B), 42(M) can allow the client device 48 to determine a boundary of possible locations of the client device 48. Location information 50 from three (3) or more ultrasound beacons 42(1)-42(B), 42(M) can allow the client device 48 to determine exact locations relative to the two ultrasound beacons 42(1)-42(B), 42(M). As a non-limiting example, this relative location can be an absolute (i.e., non-relative) location (e.g., coordinates, also e.g., X, Y, and/or Z (i.e., longitude, latitude, and/or altitude) coordinates) if the location information 50 of the ultrasound beacons 42(1)-42(B), 42(M) provided to the client device 48 are absolute locations.

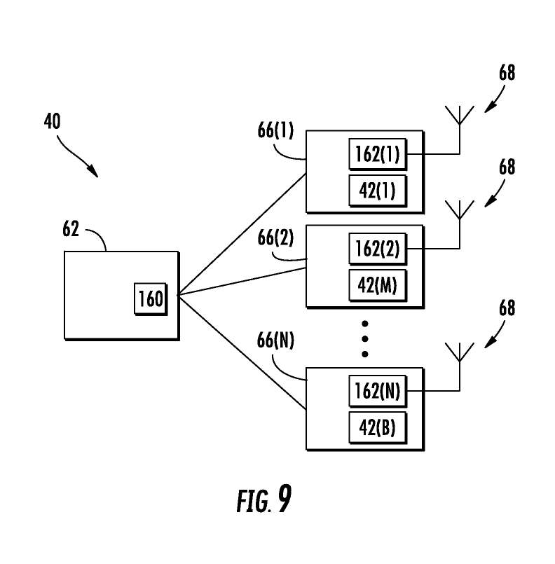

With continuing reference to FIG. 7A, the client device 48 can store its determined location in memory 160 and/or communicate this determined location to another device or network (block 142 in FIG. 7A). For example, as illustrated in FIG. 8, the client device 48 may include a RF transceiver 164 coupled to the controller 150 to process RF communications. The RF transceiver 164 is coupled to a RF antenna 166 for RF wireless transmissions and receptions. As a non-limiting example, the client device 48 could transmit the determined location wirelessly in a RF communication through the RF transceiver 164 and RF antenna 166 to another device or network. For example, the client device 48 could wirelessly transmit the determined location to a remote unit 66(1)-66(N) in the distributed communications system 40 in FIG. 2. Thus, the client device 48 could use the distributed communication system 40 to also distribute its determined location. The identification of the client device 48 may also be included in this RF communication. The remote unit 66(1)-66(N) could distribute this determined location of the client device 48 as an uplink communications signal 56U to the central unit 62. The determined location of the client device 48 could be stored in memory 150 of the central unit 62, as illustrated in FIG. 9. The determined location of the client device 48 could also be communicated by the central unit 62 to a base station 58 and/or the network 60. The process can repeat by returning back to block 110 in FIG. 7A until the next recording is triggered by the controller 150.

As discussed above and illustrated in FIG. 2, the ultrasound beacons 42(1)-42(B), 42(M) are provided in the distributed communications system 40 apart from other components in the distributed communications system 40. However, the ultrasound beacons 42(1)-42(B), 42(M) could be co-located and/or included in the other components and/or their housings in the distributed communications system 40. For example, as illustrated in FIG. 9, the ultrasound beacons 42(1)-42(B), 42(M) are shown as being co-located and included in the remote units 66(1)-66(N). In this manner, if the determined locations of the client devices 48 are provided to the remote unit 66(1)-66(N), wireless RF communications through the RF antenna 68 coupled to a RF interface 152(1)-152(N) in the remote units 66(1)-66(N) to do so would not be necessary. The ultrasound beacons 42(1)-42(B), 42(M) could provide the determined location information of the client devices 48 to the remote unit 66(1)-66(N) over wired connections/interfaces. Further, in this arrangement, if the synchronization information 51 is provided through the remote units 66(1)-66(N) to the ultrasound beacons 42(1)-42(B), 42(M), RF communications would not be necessary to provide the synchronization information 51 to the ultrasound beacons 42(1)-42(B), 42(M). The synchronization information 51 could be provided through wired connections/interfaces from the remote units 66(1)-66(N) to the ultrasound beacons 42(1)-42(B), 42(M).

As discussed above, the ultrasound beacons 42(1)-42(B), 42(M) and client devices 48 are configured to execute instructions from an exemplary computer-readable medium (i.e., instructions in memory) to perform the operations and functions described above. The term “computer-readable medium” includes a single medium or multiple media (e.g., a centralized or distributed database, and/or associated caches and servers) that store the one or more sets of instructions, and to include any medium that is capable of storing, encoding or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical and magnetic medium, and carrier wave signals.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.), a machine-readable transmission medium (electrical, optical, acoustical or other form of propagated signals (e.g., carrier waves, infrared signals, digital signals, etc.)), etc.

Unless specifically stated otherwise as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. The embodiments described herein are not described with reference to any particular programming language and a variety of programming languages may be used to implement the teachings of the embodiments as described herein.

The various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor or any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art.

The operations described herein may be performed in numerous different sequences other than as illustrated. Operations described in a single operational step may actually be performed in a number of different steps, and one or more operational steps may be combined.

The terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. The optical fibers disclosed herein can be single mode or multi-mode optical fibers.

The antenna arrangements may include any type of antenna desired, including dipole, monopole, and slot antennas. The distributed communications systems that employ the antenna arrangements disclosed herein could include any type or number of communications mediums, including but not limited to electrical conductors, optical fiber, and air (i.e., wireless transmission). The systems may distribute and the antenna arrangements disclosed herein may be configured to transmit and receive any type of communications signals, including but not limited to RF communications signals and digital data communications signals, examples of which are described in U.S. patent application Ser. No. 12/892,424 entitled “Providing Digital Data Services in Optical Fiber-based Distributed Radio Frequency (RF) Communications Systems, And Related Components and Methods,” incorporated herein by reference herein. Multiplexing, such as WDM and/or FDM, may be employed in any of the systems described herein, such as according to the examples in U.S. patent application Ser. No. 12/892,424.

The description and claims are not to be limited to the specific embodiments disclosed and modifications and other embodiments are intended to be included within the scope of the appended claims. The embodiments cover the modifications and variations of the embodiments provided they come within the scope of the appended claims and their equivalents. Although specific terms are employed herein, they are used in a generic and descriptive sense only and not for purposes of limitation.

1. An ultrasound beacon for facilitating client devices determining their location in a distributed communications system, comprising:
a controller;
an ultrasound emitter coupled to the controller, the ultrasound emitter configured to emit ultrasound pulses over at least one speaker; and
a radio-frequency (RF) receiver coupled to the controller, the RF receiver configured to receive RF synchronization signals comprising synchronization information;
the controller configured to:
synchronize an internal clock based on the received synchronization information; and
cause the ultrasound emitter to emit ultrasound pulses in synchronization based on the synchronization information with other ultrasound beacons among an ultrasound beacon cluster, to client devices located in the distributed communications system.

2. The ultrasound beacon of claim 1, wherein the controller is further configured to not communicate the synchronization information to the client devices.

3. The ultrasound beacon of claim 1, wherein the controller is configured to cause the ultrasound emitter to emit the ultrasound pulses in approximately one millisecond (1 ms) durations.

4. The ultrasound beacon of claim 1, wherein the RF receiver is configured to receive the RF synchronization signals in a communications protocol selected from the group consisting of radio frequency identification (RFID), Zigbee, and Dash7.

5. The ultrasound beacon of claim 1, further comprising:
memory coupled to the controller, wherein location information of the ultrasound beacon is stored in the memory; and
wherein the controller is further configured to periodically encode the location information in the ultrasound pulses emitted to the client devices.

6. The ultrasound beacon of claim 5, wherein the controller is configured to cause the ultrasound emitter to emit the ultrasound pulses to the client devices simultaneously with other ultrasound beacons in an ultrasound beacon cluster emitting ultrasound pulses to the client devices, based on the synchronized internal clock.

7. The ultrasound beacon of claim 6, wherein the ultrasound emitter is configured to emit the ultrasound pulses to the client devices at a unique carrier frequency among the other ultrasound beacons in the ultrasound beacon cluster.

8. The ultrasound beacon of claim 5, wherein the controller is configured to cause the ultrasound emitter to emit the ultrasound pulses to the client devices in sequence with other ultrasound beacons in an ultrasound beacon cluster emitting ultrasound pulses to the client devices, based on the synchronized internal clock.

9. The ultrasound beacon of claim 8, wherein the controller is configured to cause the ultrasound emitter to emit the ultrasound pulses to the client devices at the same carrier frequency with the other ultrasound beacons in the ultrasound beacon cluster.

10. The ultrasound beacon of claim 1, wherein the controller is configured to:
cause the ultrasound emitter to emit the ultrasound pulses to the client devices in sequence with other ultrasound beacons in an ultrasound beacon cluster emitting ultrasound pulses to the client devices, based on the synchronized internal clock; and
cause the ultrasound emitter to emit the ultrasound pulses to the client devices at a unique carrier frequency among the other ultrasound beacons in the ultrasound beacon cluster.

11. The ultrasound beacon of claim 1, wherein
the controller is further configured to synchronize an internal clock based on the received synchronization information; and
the controller is configured to cause the ultrasound emitter to emit ultrasound pulses in synchronization based on the synchronized internal clock with other ultrasound beacons among an ultrasound beacon cluster, to client devices located in the distributed communications system.

12. A distributed communications system, comprising:
an ultrasound beacon cluster comprised of:
a master ultrasound beacon; and
a plurality of non-master ultrasound beacons;
the master ultrasound beacon and the plurality of non-master ultrasound beacons each configured to:
receive RF synchronization signals comprising synchronization information;
emit ultrasound pulses to client devices located in the distributed communications system in synchronization with the other ultrasound beacons in the ultrasound beacon cluster based on the synchronization information; and
the master ultrasound beacon further configured to periodically encode location information of the master ultrasound beacon and the plurality of non-master ultrasound beacons in the ultrasound pulses emitted to the client devices.

13. The distributed communications system of claim 12, wherein the master ultrasound beacon and the plurality of non-master ultrasound beacons are each configured to emit the ultrasound pulses to the client devices simultaneously, based on respective synchronized internal clocks.

14. The distributed communications system of claim 13, wherein the master ultrasound beacon and the plurality of non-master ultrasound beacons are each configured to emit the ultrasound pulses to the client devices at a unique carrier frequency among the ultrasound beacons in the ultrasound beacon cluster.

15. The distributed communications system of claim 12, wherein the master ultrasound beacon and the plurality of non-master ultrasound beacons are each configured to emit the ultrasound pulses to the client devices in sequence with the other ultrasound beacons in the ultrasound beacon cluster, based on the respective synchronization information.

16. The distributed communications system of claim 15, wherein the master ultrasound beacon and the plurality of non-master ultrasound beacons are each configured to emit the ultrasound pulses to the client devices at the same carrier frequency.

17. The distributed communications system of claim 12, wherein the master ultrasound beacon and the plurality of non-master ultrasound beacons are each configured to:
emit the ultrasound pulses to the client devices in sequence with the other ultrasound beacons in an ultrasound beacon cluster, based on the respective synchronization information; and
emit the ultrasound pulses to the client devices at a unique carrier frequency among the other ultrasound beacons in the ultrasound beacon cluster.

18. The distributed communications system of claim 12, wherein at least one of the master ultrasound beacon and at least one of the plurality of non-master ultrasound beacons is provided in a remote unit in the distributed communications system, the remote unit configured to receive downlink communications signals from a central unit over a downlink communications medium and wirelessly transmit the downlink communications signals over at least one RF antenna to the client devices.

19. The distributed communications system of claim 18, wherein an RF receiver is configured to receive the synchronization information from the central unit in the RF synchronization signals received over the downlink communications medium.

20. The distributed communications system of claim 18, wherein the remote unit is configured to receive location information from the client device based on the client device determining location from receipt of ultrasound pulses emitted by the master ultrasound beacon and the plurality of non-master ultrasound beacons to the client device.

21.-56. (canceled)
